(19) United States
(12) Patent Application Publication
(10) Pub. No.: US 2014/0212133 A1
(43) Pub. Date: Jul. 31, 2014

(54) CONTROL DEVICE FOR OPTICAL CHANNEL MONITOR, OPTICAL TRANSMISSION DEVICE, AND METHOD OF CONTROLLING OPTICAL CHANNEL MONITOR

(71) Applicant: FUJITSU LIMITED, Kawasaki-shi (JP)

(72) Inventors: Masumi Kobayashi, Fukuoka (JP); Tatsuo Nagayoshi, Ohnojyou (JP); Masanori Eiro, Dazaifu (JP); Yoshikazu Nakanishi, Fukuoka (JP); Masato Miyake, Fukuoka (JP)

(73) Assignee: FUJITSU LIMITED, Kawasaki-shi (JP)

(21) Appl. No.: 14/088,890

(22) Filed: Nov. 25, 2013

(30) Foreign Application Priority Data
Jan. 30, 2013 (JP) 2013-016106

(51) Int. Cl. H04B 10/079

(52) U.S. Cl. CPC H04B 10/0795
USPC 398/25

(57) ABSTRACT

A control device for an optical channel monitor includes: at least one of a processor and a circuit configured to stop calibration of a measured wavelength when no peak intensity of a wavelength of incoming light is detected, the optical channel monitor measuring a light intensity at the measured wavelength, the at least one of processor and circuit configured to determine presence of a peak intensity in the incoming light when detecting the incoming light with a light intensity equal to or more than a given intensity, the at least one of processor and circuit configured to permit the calibration of the measured wavelength which has been stopped to be resumed when the wavelength peak is determined to be present.

### CROSS-REFERENCE TO RELATED APPLICATION

This application is based upon and claims the benefit of priority from the prior Japanese Patent Application No. 2013-016106 filed on Jan. 30, 2013, the entire contents of which are incorporated herein by reference.

### FIELD

The embodiments discussed herein are related to a control device for an optical channel monitor, an optical transmission device, and a method of controlling an optical channel monitor.

### BACKGROUND

Certain types of optical transmission devices for transmitting signal light such as wavelength division multiplexing (WDM) signal light are equipped with an optical channel monitor (OCM) that monitors the light intensities of one or more optical signals contained in the signal light.

If an OCM goes down, the optical transmission device will be unable to adjust the light intensities of optical signals, so that the optical transmission device fails. If the failed optical transmission device is used in a trunk network optical communication system, communication troubles will occur over a wide area.

A variable wavelength selective filter is known which includes: a first polarization unit that branches incoming light into TM mode light and TE mode light; first and second optical waveguides that guide the TM mode light and TE mode light, respectively; and an RF signal application unit that applies RF signals to the first and second optical waveguides. In addition, this variable wavelength selective filter further includes a light intensity detection unit, a maximum intensity identification unit, and a frequency control unit. The light intensity detection unit detects the intensity of the outgoing light. The maximum intensity identification unit receives the light intensity from the light intensity detection unit while varying the frequency of an RF signal generated by an RF signal generation unit, and identifies the maximum intensity of an optical signal at a given wavelength. The frequency control unit controls the RF signal generation unit to generate an RF signal of a frequency at which the maximum intensity identification unit identifies the maximum light intensity (for example, refer to Japanese Laid-open Patent Publication No. 2000-241782).

A wavelength detection method is known which includes: a wavelength scanning step of periodically scanning a wavelength range covering an optical signal to measure a detection wavelength; and a detection step of detecting an event in which a difference between the detection wavelength and the wavelength of the optical signal becomes equal to or less than a preset value. In addition, this wavelength detection method further includes: a power detection step of detecting the power of the optical signal when the wavelength difference becomes equal to or less than the preset value at the detection step; and a control step of adjusting the excitation of an optical amplifier on the basis of power information for each wavelength component which is acquired at the power detection step (for example, refer to Japanese Laid-open Patent Publication No. 2001-069086).

An optical signal detection device is known which includes an optical switch and an array waveguide diffraction grating. The optical switch switches between two paths of an optical signal. The array waveguide diffraction grating performs wavelength separation, and has incident light waveguides connected to the respective paths and a slab waveguide connected to the incident light waveguides such that respective locations or angles of light beams from the incident light waveguides differ from each other. The optical signal detection device further includes a detector and an arithmetic circuit. The detector converts an optical signal from the array waveguide diffraction grating into an electrical signal. The arithmetic circuit calculates the respective strengths of the electrical signals into which the detector converts the optical signals passing through the corresponding incident light waveguides (for example, refer to Japanese Laid-open Patent Publication No. 2010-226587).

It is known that automatic level control (ALC) and automatic gain control (AGC) are performed when monitor signal light is demodulated and the change in the number of channels is identified (for example, refer to Japanese Laid-open Patent Publication No. 2007-312155).

A wavelength selective switch is known which includes an optical channel monitor unit that has an ASE light detection unit and an ASE optical signal processing unit. The ASE light detection unit detects part of amplified spontaneous emission (ASE) light on at least one of the short and long wavelength sides of a wavelength multiplexing signal. The ASE optical signal processing unit calculates an amount by which the center wavelength of the detected ASE light is shifted from a reference wavelength. The wavelength selective switch further includes a path control unit provided with a driving unit that relatively shifts the location of incident light with each wavelength from a switching element array, on the basis of the shift amount (for example, refer to Japanese Laid-open Patent Publication No. 2012-141478).

A method of monitoring and compensating for the dispersion of an optical signal communicated in an optical network is known. This method includes: receiving an optical signal having a plurality of channels; filtering one channel part of the channels; measuring the optical dispersion of the part by analyzing the part; and compensating for the optical dispersion on the basis of the measured dispersion (for example, refer to Japanese Laid-open Patent Publication No. 2011-101365).

A method of collecting data from an optical channel monitor is known which is used to avoid the malfunction of a device when the data measured by the optical channel monitor contains a large amount of error during the variation in an optical power in a transmission path. This method monitors the optical power of entire incoming signal light to the optical channel monitor that is performing a scanning operation. When detecting a variation in the optical power that is equal to or more than a preset threshold, the method discards information regarding the optical power of each channel and information regarding the total optical power which have been collected from the optical channel monitor, and maintains previous information (for example, refer to Japanese Laid-open Patent Publication No. 2009-152967).

An optical amplification device applied to a WDM transmission system is known which independently controls the wavelength components in multi-wavelength signal light propagating in a WDM transmission path (for example, refer to Japanese Laid-open Patent Publication No. 2006-286918).

An OCM selects light whose wavelength is the same as that of an optical signal, and measures the intensity of the selected light. When monitoring the light intensities of optical signals with different wavelengths, the OCM varies a measured wavelength by changing a setting parameter, and sequentially measures the light intensities.

The measured wavelength for an OCM may vary due to the change in the property of an element with time. The OCM accordingly calibrates the measured wavelength by using reference light with a known wavelength. This reference light may be, for example, light generated by a specific light source or an optical signal with a known wavelength such as WDM signal light.

When an optical signal with a known wavelength is used as the reference light, there are cases where no optical signal enters the OCM or ASE light enters the OCM due to the occurrence of a certain failure. In such a case, no wavelength peak, or no spectrum peak, is found in the incident light. Performing the calibration in this state may result in the increase in a wavelength error.

### SUMMARY

According to an aspect of the embodiment, a control device for an optical channel monitor includes: at least one of a processor and a circuit configured to stop calibration of a measured wavelength when no peak intensity of a wavelength of incoming light is detected, the optical channel monitor measuring a light intensity at the measured wavelength, the at least one of processor and circuit configured to determine presence of a peak intensity in the incoming light when detecting the incoming light with a light intensity equal to or more than a given intensity, the at least one of processor and circuit configured to permit the calibration of the measured wavelength which has been stopped to be resumed when the wavelength peak is determined to be present.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates respective configurations of first and second optical transmission devices according to an embodiment;

FIG. 2 illustrates an exemplary configuration of an OCM control unit;

FIG. 3 illustrates the state transition of an OCM unit;

FIG. 4 is an exemplary flowchart of a scan stop process performed by the first optical transmission device;

FIG. 5 is an exemplary flowchart of a scan permit process performed by the first optical transmission device;

FIG. 6 is a sequence diagram of a first example of an operation of the first optical transmission device.

FIG. 7 illustrates respective configurations of first and second optical transmission devices according to another embodiment;

FIG. 8 is a sequence diagram of a second example of an operation of the first optical transmission device;

FIG. 9 illustrates respective configurations of first and second optical transmission devices according to still another embodiment; and

FIG. 10 is a sequence diagram of a third example of an operation of the first optical transmission device.

### DESCRIPTION OF EMBODIMENTS

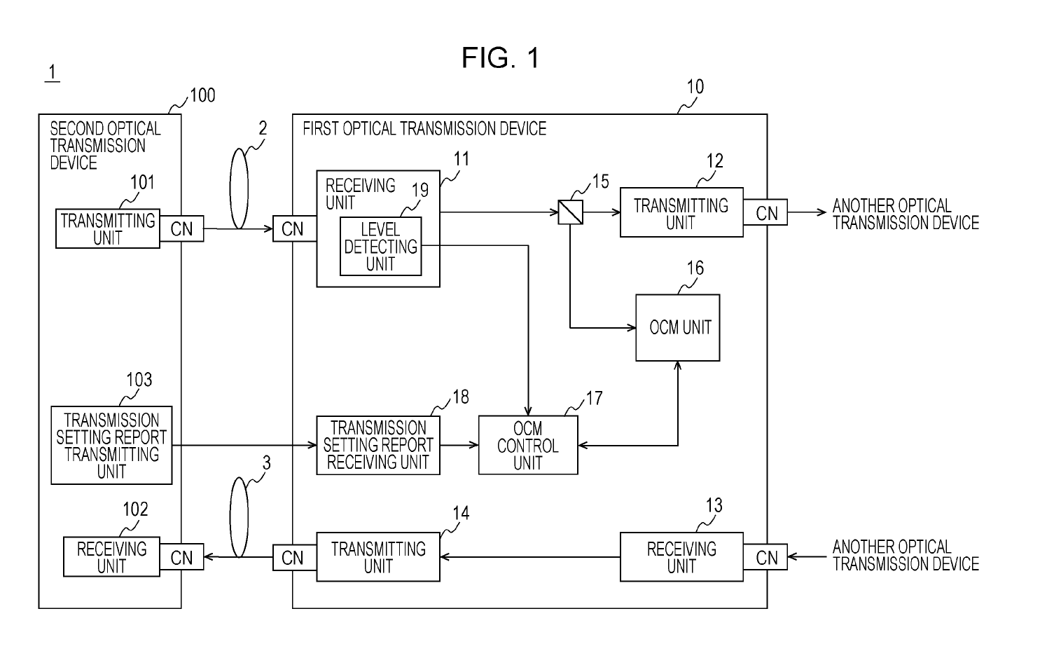

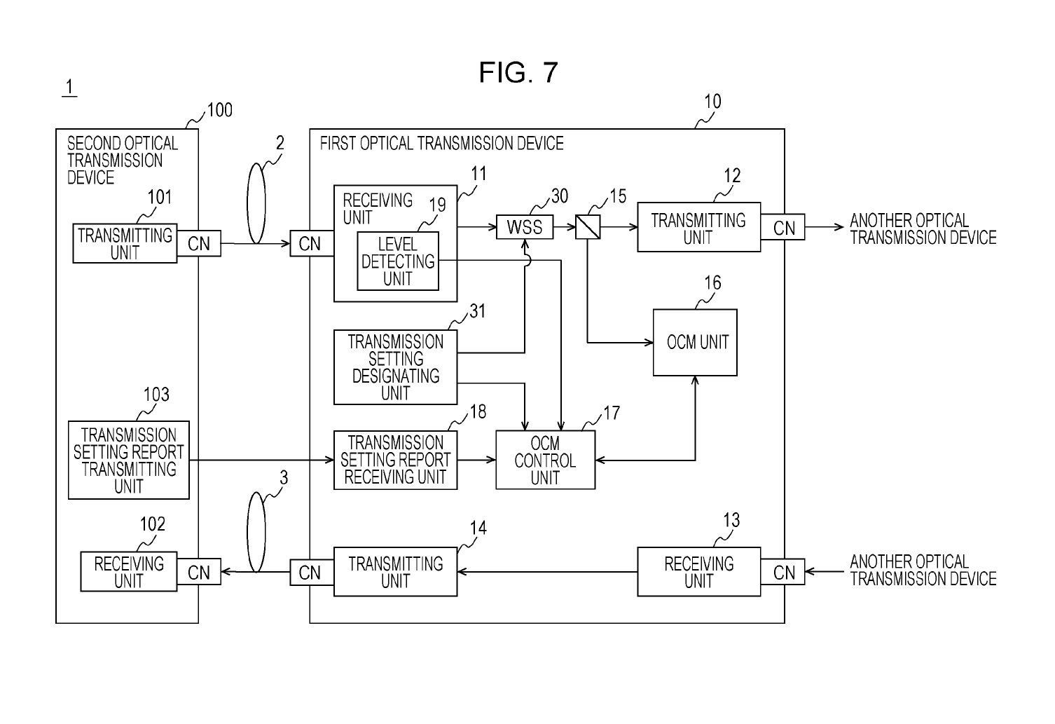

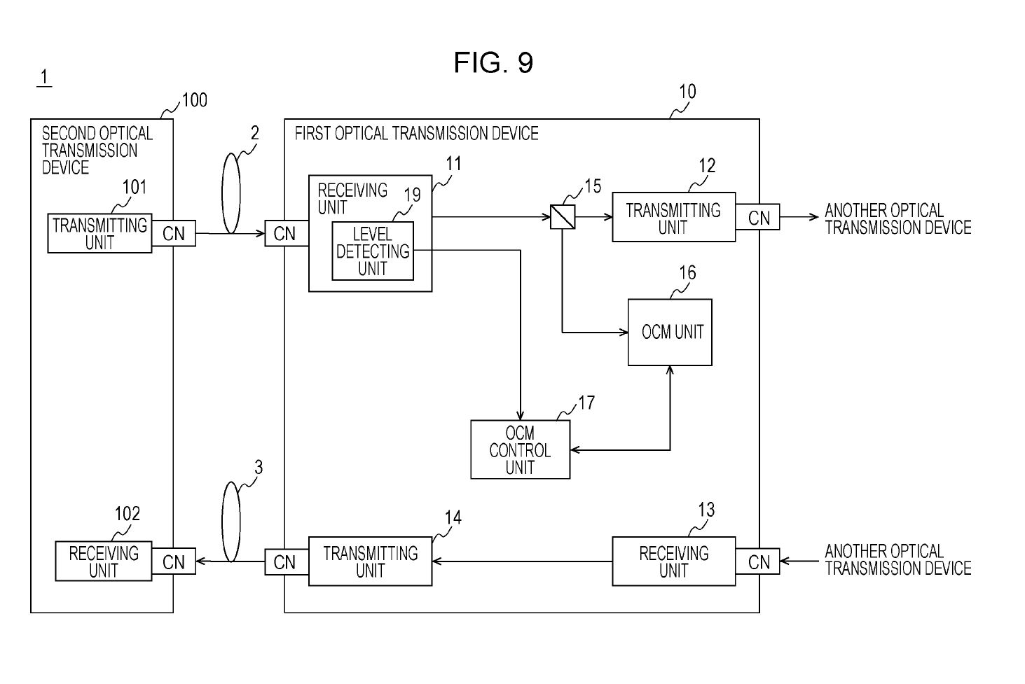

Hereinafter, an embodiment will be described with reference to the accompanying drawings. FIG. 1 illustrates configurations of first and second optical transmission devices according to this embodiment. An optical transmission system 1 includes a first optical transmission device 10 and a second optical transmission device 100. In FIG. 1, constitute elements related to primary functions of this embodiment are illustrated. The first optical transmission device 10 and the second optical transmission device 100 may further include some other constitute elements in addition to those in FIG. 1. This also applies to FIGS. 7 and 9.

The first optical transmission device 10 and the second optical transmission device 100 are interconnected through optical transmission paths 2 and 3 each of which is configured with, for example, an optical fiber. Through the optical transmission path 2, optical signals are transmitted from the second optical transmission device 100 to the first optical transmission device 10. Likewise, through the optical transmission path 3, optical signals are transmitted from the first optical transmission device 10 to the second optical transmission device 100. In FIG. 1, reference characters CN each denote an optical connector. This also applies to FIGS. 7 and 9.

The optical transmission devices 10 and the second optical transmission device 100 each may transmit, for example, WDM signal light generated by multiplexing multiple optical signals with different wavelengths. That is, WDM signal light may enter the first optical transmission device 10, and both the optical transmission paths 2 and 3 may carry the WDM signal light.

The first optical transmission device 10 includes receiving units 11 and 13, transmitting units 12 and 14, a beam splitter 15, an OCM unit 16, an OCM control unit 17, and a transmission setting report receiving unit 18. The second optical transmission device 100 includes a transmitting unit 101, a receiving unit 102, and a transmission setting report transmitting unit 103.

In the second optical transmission device 100, the transmitting unit 101 transmits an optical signal to the first optical transmission device 10 through the optical transmission path 2. In the first optical transmission device 10, the receiving unit 11 receives the optical signal from an optical connector to which the optical transmission path 2 between the optical transmission devices 10 and the second optical transmission device 100 is connected. The optical signal received by the receiving unit 11 enters the transmitting unit 12 through the beam splitter 15. The transmitting unit 12 transmits the optical signal to another optical transmission device (not illustrated).

The receiving unit 13 receives an optical signal transmitted from another optical transmission device. The optical signal received by the receiving unit 13 enters the transmitting unit 14, and the transmitting unit 14 transmits this optical signal to the second optical transmission device 100. In the second optical transmission device 100, the receiving unit 102 receives the optical signal transmitted from the first optical transmission device 10.

The beam splitter 15 splits incoming light into two light beams. The OCM unit 16 receives one of the light beams, and measures the light intensities of optical signals contained in the received light beam at corresponding wavelengths.

The OCM unit 16 also calibrates a wavelength at which a light intensity is to be measured. In more detail, the OCM unit 16 calibrates a relationship between a wavelength at which the light intensity of an optical signal peaks and setting parameters used to set a wavelength at which a light intensity is to be measured to the wavelength of an optical signal. For example, the setting parameter may cause a tunable filter to specify a wavelength at which the OCM unit 16 measures a light intensity. In the following description, a wavelength at which the OCM unit 16 measures a light intensity may be referred to as a “measured wavelength.”

Exemplary procedures for calibrating the measured wavelength are as follows. The OCM unit 16 uses incoming light as reference light upon calibration, and stores the above relationship.

During the calibration, the OCM unit 16 scans the light intensity of incoming light at corresponding wavelengths while changing the setting parameter. When detecting the peak of the light intensity, the OCM unit 16 searches the setting parameters each of which indicates a relationship with the wavelength of incoming light, and identifies a setting parameter that is closest to that used to detect this peak.

The OCM unit 16 stores one of wavelengths stored before the calibration which corresponds to the identified setting parameter and the setting parameter used to detect the intensity peak, in relation to each other. If the setting parameter related to the wavelength of the signal light before the calibration does not greatly differ from the setting parameter used to detect this wavelength during the calibration, the setting parameter is considered to be calibrated properly.

The OCM unit 16 may measure the light intensities of the optical signals at corresponding wavelengths and calibrate the measured wavelength simultaneously, on the basis of the wavelength peak detected through the scanning. Alternatively, the OCM unit 16 may perform the measurement and calibration separately from each other.

As described above, the OCM unit 16 calibrates the measured wavelength by using the incoming light to the first optical transmission device 10 as the reference light. However, if no optical signal enters the first optical transmission device 10 or ASE light enters the first optical transmission device 10, for example, the OCM unit 16 may fail to detect a wavelength peak.

If the OCM unit 16 calibrates the measured wavelength during a period in which a wavelength peak is not detected, an error may arise between the wavelength stored in the OCM unit 16 in relation to the setting parameter and the measured wavelength, and exceed wavelength spacing between optical signals.

For example, there are cases where a setting parameter used to actually measure signal light with a certain wavelength may be closer to a setting parameter related to another optical signal than to this optical signal. In this case, it is difficult to calibrate the measured wavelength even when an optical signal enters the OCM unit 16.

When the OCM unit 16 fails to detect a wavelength peak of incoming light to the first optical transmission device 10, the OCM control unit 17 causes the OCM unit 16 to stop scanning a light intensity during the calibration of the measured wavelength. However, when determining that the incoming light has a wavelength peak after stopping the scanning, the OCM control unit 17 permits the OCM unit 16 to scan a light intensity. The OCM control unit 17 may be implemented with hardware including a control circuit equipped with, for example, at least one of a central processing unit (CPU), a micro-processing unit (MPU), and a logic circuit, and at least one memory.

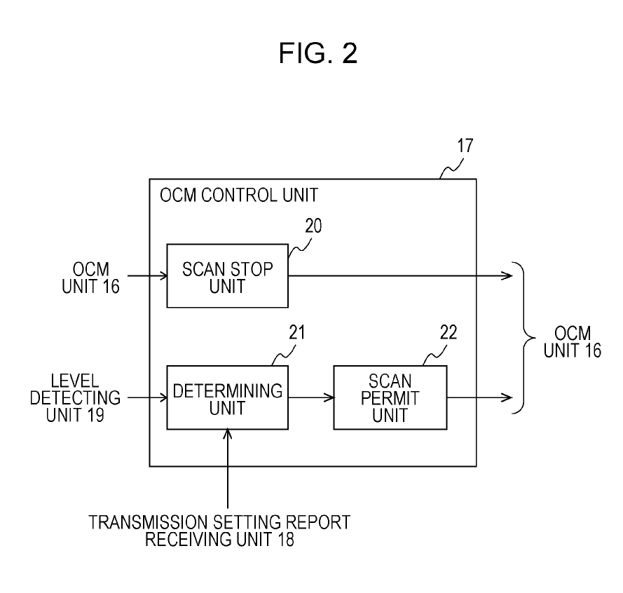

FIG. 2 illustrates an exemplary configuration of the OCM control unit 17. The OCM control unit 17 includes a scan stop unit 20, a determining unit 21, and a scan permit unit 22. When a preset condition for stopping scanning is satisfied, the scan stop unit 20 outputs, to the OCM unit 16, a scan stop instruction that is an instruction for stopping scanning a light intensity during the calibration of the measured wavelength. For example, when the OCM unit 16 fails to detect a peak of a light intensity over a range of one wavelength, the scan stop unit 20 may output a scan stop instruction to the OCM unit 16. The scan stop unit 20 and the scan permit unit 22 exemplify a calibration stop unit and a calibration permit unit, respectively.

Once receiving a scan stop instruction, the OCM unit 16 enters a scan stop state in which the scanning of a light intensity is stopped during the calibration of the measured wavelength. The scan stop unit 20 may output a scan stop instruction when the OCM unit 16 successively fails to detect an intensity peak for a preset number of times C. This makes it possible to keep the OCM unit 16 from accidentally entering the scan stop state in response to the temporary interruption of an optical signal.

The determining unit 21 determines whether or not a given scan permit condition, which is a condition for permitting the scanning of a light intensity during the calibration of the measured wavelength, is satisfied. For example, the given scan permit condition may be determined to be satisfied when both the following conditions 1 and 2 are fulfilled.

1. Light with a light intensity equal to or more than that of at least one optical signal enters the receiving unit 11.

2. Incoming light to the OCM unit 16 is determined to have a wavelength peak.

Condition 2 is set in addition to condition 1 in consideration of a case where ASE light has a light intensity equal to or more than that of at least one optical signal. That is, both conditions 1 and 2 are set in order to keep the calibration of the measured wavelength from being permitted depending on only the light intensity of incoming ASE light.

When a level detecting unit 19 provided in the receiving unit 11 detects incoming light with a light intensity equal to or more than that of at least one optical signal, the level detecting unit 19 outputs a detection signal to the determining unit 21. In response to the detection signal, the determining unit 21 determines the presence of a wavelength peak in incoming light to the OCM unit 16.

The determining unit 21 may determine the presence of a wavelength peak, for example, on the basis of the setting of the second optical transmission device 100 in which one or more optical signals are transmitted to the first optical transmission device 10. In the second optical transmission device 100, the transmission setting report transmitting unit 103 regularly transmits transmission setting reports to the first optical transmission device 10. Each transmission setting report indicates that the second optical transmission device 100 is set to transmit one or more optical signals to the first optical transmission device 10. In the first optical transmission device 10, the transmission setting report receiving unit 18 receives the transmission setting reports.

In the case where the second optical transmission device 100 and the first optical transmission device 10 are disposed on the same shelf, the transmission setting reports may be transmitted from the transmission setting report transmitting unit 103 to the transmission setting report receiving unit 18 through electrical communication using a communication line on the shelf. Alternatively, the transmission setting reports may be transmitted through optical communication using, for example, WDM signal light. The transmission setting reports may be transmitted either directly and autonomously or indirectly through an intermediate control device.

Once receiving a transmission setting report, the determining unit 21 determines that the scan permit condition is satisfied. In response, the scan permit unit 22 outputs a scan permit instruction to the OCM unit 16, indicating the permit of the scanning of a light intensity during the calibration of the measured wavelength. Once receiving the scan permit instruction, the OCM unit 16 enters a scan enable state in which a light intensity is scanned. If the OCM unit 16 enters the scan enable state while the intensity of incoming light is unstable, the OCM unit 16 may repeatedly transit between the scan stop state and the scan enable state. In order to avoid this phenomenon, it is preferable for the scan permit unit 22 to halt the output of the scan permit instruction until the scan permit condition is kept satisfied over a preset period P.

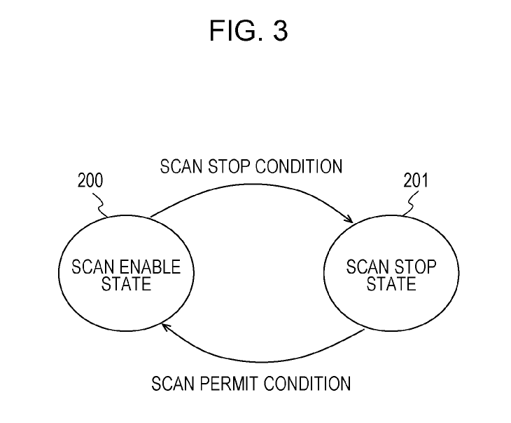

FIG. 3 illustrates the state transition of the OCM unit 16. While being in a scan enable state 200, the OCM unit 16 regularly scans a light intensity during the calibration of the measured wavelength. When the scan stop condition is satisfied, the OCM unit 16 transits from the scan enable state 200 to a scan stop state 201. While being in the scan stop state 201, the OCM unit 16 stops scanning a light intensity.

When the scan permit condition is satisfied, the OCM unit 16 transits from the scan stop state 201 to the scan enable state 200. Then, the OCM unit 16 resumes regular scanning of a light intensity during the calibration of the measured wavelength.

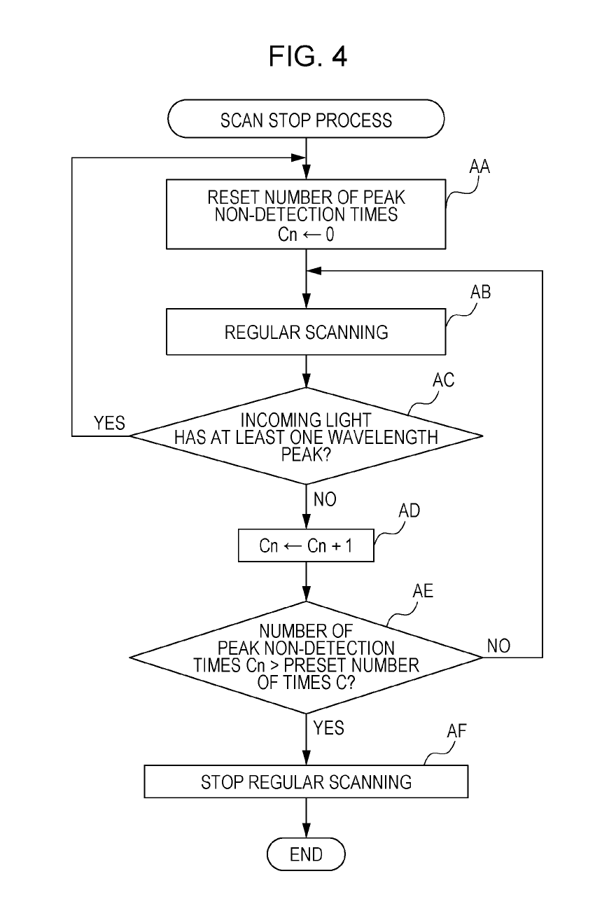

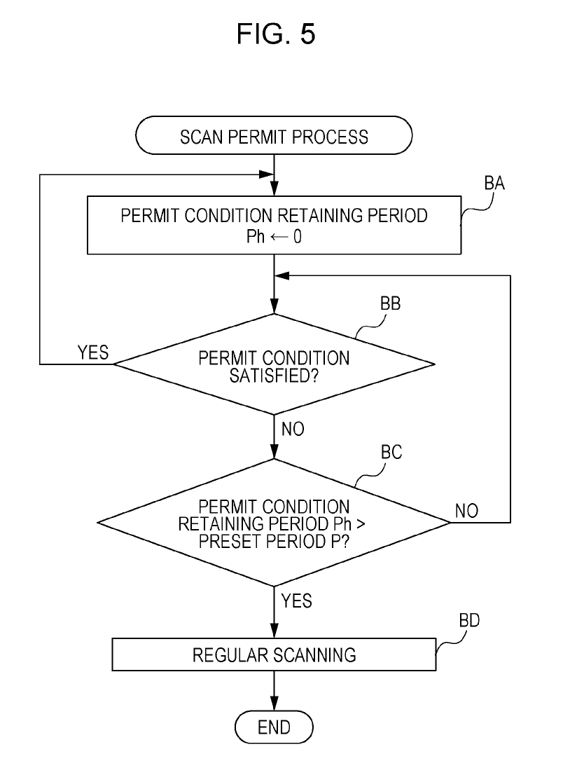

FIG. 4 is a flowchart of an exemplary scan stop process performed by the first optical transmission device 10. Operations that will be described with reference to FIG. 4 may be interpreted as a method involving a plurality of procedures. Herein, a term “operation” may be replaced by “step.” This also applies to FIGS. 5, 6, 8 and 10.

In operation AA, the scan stop unit 20 resets the number of peak non-detection times Cn to “0.” The number of peak non-detection times Cn is a variable that represents the number of times for which the OCM unit 16 successively fails to detect the peak of a light intensity.

In operation AB, the OCM unit 16 regularly scans a light intensity during the calibration of the measured wavelength. In operation AC, the OCM unit 16 or the scan stop unit 20 determines whether or not incoming light has at least one wavelength peak. If the incoming light has at least one wavelength peak (“Y” in operation AC), this process returns to operation AA. Otherwise, if the incoming light has no wavelength peak (“N” in operation AC), this process proceeds to operation AD.

In operation AD, the scan stop unit 20 increments the number of peak non-detection times Cn by 1. In operation AE, the scan stop unit 20 determines whether or not the number of peak non-detection times Cn exceeds the preset number of times C. If the number of peak non-detection times Cn exceeds the preset number of times C (“Y” in operation AE), this process proceeds to operation AF. Otherwise, if the number of peak non-detection times Cn does not exceed the preset number of times C (“N” in operation AE), this process returns to operation AB.

In operation AF, the scan stop unit 20 outputs a scan stop instruction to the OCM unit 16. In response, the OCM unit 16 enters the scan stop state, and then stops the regular scanning of a light intensity.

FIG. 5 is a flowchart of an exemplary scanning permit process performed by the first optical transmission device 10. In operation BA, the scan permit unit 22 resets a permit condition retaining period Ph to “0.” The permit condition retaining period Ph is a variable that represents a time period during which the scan permit condition is kept satisfied.

In operation BB, the determining unit 21 determines whether or not the scan permit condition is satisfied. If the scan permit condition is satisfied (“Y” in operation BB), this process returns to operation BA. Otherwise, if the scan permit condition is not satisfied (“N” in operation BB), this process proceeds to operation BC.

In operation BC, the scan permit unit 22 determines whether or not the permit condition retaining period Ph is longer than a preset period P. If the permit condition retaining period Ph is longer than the preset period P (“Y” in operation BC), this process proceeds to operation BD. Otherwise, if the permit condition retaining period Ph is not longer than the preset period P (“N” in operation BC), this process returns to operation BB.

In operation BD, the scan permit unit 22 outputs a scan permit instruction to the OCM unit 16. In response, the OCM unit 16 enters the scan permit condition, and then starts regular scanning of a light intensity during the calibration of the measured wavelength.

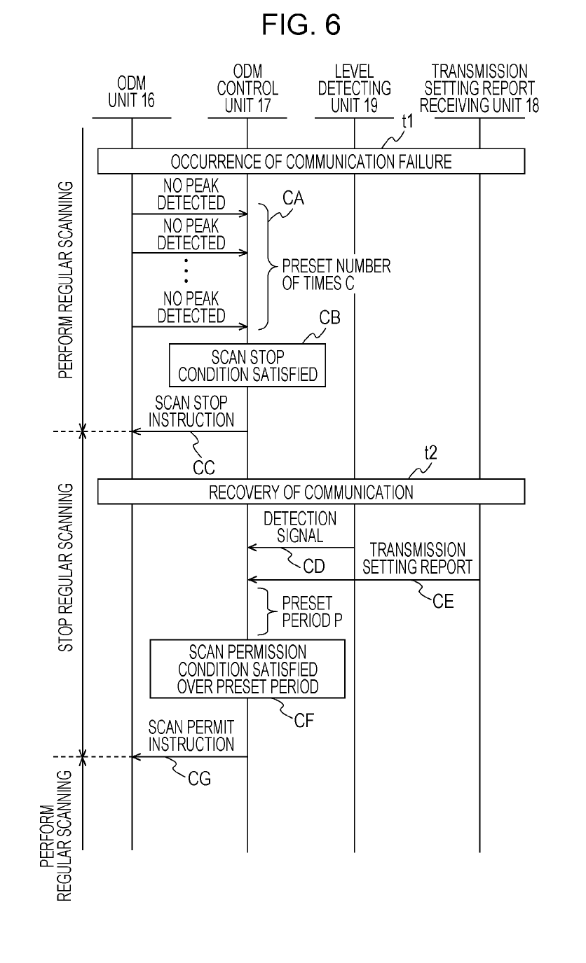

FIG. 6 is a sequence diagram of an operation of the first optical transmission device 10 in this embodiment. In this sequence diagram, an optical signal is assumed not to enter the first optical transmission device 10 at Time t1, in response to the occurrence of a communication failure. In operation CA, the OCM unit 16 fails to detect a wavelength peak for the preset number of times C through successive scanning of a light intensity. In operation CB, the OCM control unit 17 determines that a scan stop condition is satisfied.

In operation CC, the OCM control unit 17 outputs a scan stop instruction to the OCM unit 16. In response, the OCM unit 16 stops the regular scanning of a light intensity during the calibration of the measured wavelength.

At Time t2, the communication is recovered, and the optical signal accordingly reenters the first optical transmission device 10. In operation CD, the level detecting unit 19 outputs a detection signal to the OCM control unit 17, in response to incoming light with an intensity equal to or more than that of at least one optical signal.

In operation CE, the second optical transmission device 100 transmits a transmission setting report to the first optical transmission device 10. If the level detecting unit 19 detects incoming light with an intensity equal to or more than that of at least one optical signal and the transmission setting report receiving unit 18 receives the transmission setting report, the OCM control unit 17 determines that the scan permit condition is satisfied. In operation CF, the OCM control unit 17 determines whether or not the scan permit condition is kept satisfied over the preset period P.

If the scan permit condition is kept satisfied over the preset period P, the OCM control unit 17 outputs a scan permit instruction to the OCM unit 16 in operation CG. In response, the OCM unit 16 starts regular scanning of a light intensity during the calibration of the measured wavelength.

The foregoing embodiment keeps the optical transmission device from performing calibration with the incoming light with no wavelength peak, when an optical transmission device calibrates a measured wavelength by using incoming light as reference light. Thus, this embodiment avoids the increase in an error contained in the measured wavelength. For example, an error between a measured wavelength and a wavelength that the OCM unit 16 stores in relation to a setting parameter is kept from becoming too large to disable the calibration of the measured wavelength.

The foregoing embodiment also avoids the failure of the OCM unit 16 which would be caused by incoming light with no wavelength peak. This scheme improves the usability of the OCM unit 16, and reduces a risk that the first optical transmission device 10 fails due to the disablement of an OCM. For example, assuming that the first optical transmission device 10 is applied to trunk network optical communication, a risk that a communication failure occurs across a wide range is reduced even if the first optical transmission device 10 fails.

Next, another embodiment of a first optical transmission device 10 will be described. FIG. 7 illustrates respective configurations of first and second optical transmission devices in this embodiment. Constituent elements that are the same as those described with reference to FIG. 1 are denoted by the same reference characters, and the same functions will not be described.

A first optical transmission device 10 in this embodiment includes a wavelength selective switch (WSS) 15 and a transmission setting designating unit 31 in addition to the constituent elements in FIG. 1. The WSS 15 selects some of optical signals entering the first optical transmission device 10, the respective wavelengths of which are the same as transmission-target wavelengths for the first optical transmission device 10. The transmission setting designating unit 31 stores a transmission setting, which is setting information regarding the communication-target wavelengths for the first optical transmission device 10.

The WSS 15 selects some of optical signals entering the first optical transmission device 10, on the basis of the transmission setting of the first optical transmission device 10 which is stored in the transmission setting designating unit 31. Then, the WSS 15 enters the selected optical signals to the beam splitter 15.

Suppose the respective transmission settings differ between the first optical transmission device 10 and the second optical transmission device 100. In the configuration in which the WSS 15 is disposed on the input side of the OCM unit 16, no optical signal may be contained in incoming light to the OCM unit 16 even when an optical signal is transmitted from the second optical transmission device 100. In this case, no wavelength peak is detected from this incoming light.

The determining unit 21 accordingly determines the presence of a common wavelength between both transmission settings for the first optical transmission device 10 and the second optical transmission device 100, when determining whether or not condition 2 in the scan permit condition is fulfilled. If there is a common wavelength, the determining unit 21 determines that the incoming light to the OCM unit 16 has a wavelength peak. Otherwise, if there is no common wavelength, the determining unit 21 determines that the incoming light has no wavelength peak.

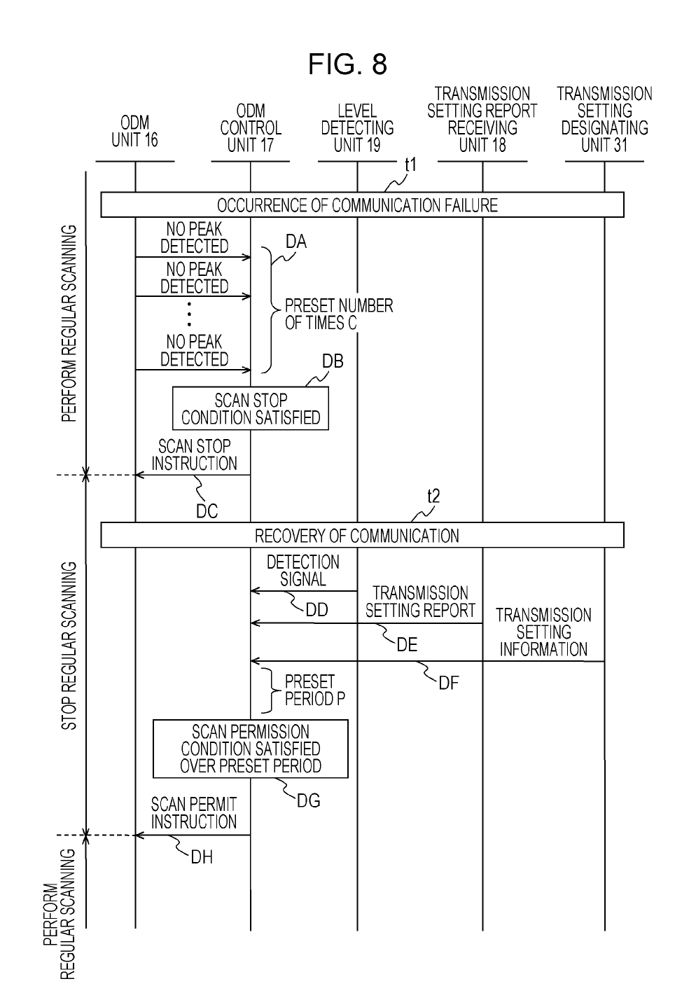

FIG. 8 is a sequence diagram of an operation of the first optical transmission device 10 in this embodiment. An optical signal does not enter the first optical transmission device 10 at Time t1 in response to the occurrence of a communication failure. Operations DA to DC are the same as operations CA to CC, respectively, in FIG. 6.

At Time t2, the communication is recovered, and the optical signal accordingly reenters the first optical transmission device 10. Operations DD and DE are the same as operations CD and CE, respectively, in FIG. 6. In operation DF, the determining unit 21 in the OCM control unit 17 receives the transmission setting for the first optical transmission device 10 from the transmission setting designating unit 31.

If the level detecting unit 19 detects incoming light with an intensity equal to or more than that of at least one optical signal and the determining unit 21 determines that there is a common wavelength between both transmission settings for the first optical transmission device 10 and the second optical transmission device 100, the OCM control unit 17 determines that the scan permit condition is satisfied. Operations DG and DH are the same as operations CF and CG, respectively, in FIG. 6.

In this embodiment, providing the WSS 15 on the input side of the OCM unit 16, which selects respective optical signals with wavelengths the same as transmission target wavelengths for the first optical transmission device 10, enables the calibration of the OCM unit 16 to be stopped when incoming light to the OCM unit 16 contains no optical signal because of a difference in transmission setting between the first optical transmission device 10 and the second optical transmission device 100.

Next, still another embodiment of a first optical transmission device 10 will be described. FIG. 9 illustrates respective configurations of first and second optical transmission devices in this embodiment. Constituent elements that are the same as those described with reference to FIG. 1 are denoted by the same reference characters, and the same functions will not be described.

When receiving a detection signal from the level detecting unit 19 which indicates the detection of incoming light with a light intensity equal to or more than that of at least one optical signal, the determining unit 21 outputs a peak detection instruction to the OCM unit 16. The peak detection instruction causes the OCM unit 16 to detect the spectrum peak of incoming light without calibrating the measured wavelength.

If the OCM unit 16 detects the spectrum peak of the incoming light in accordance with the peak detection instruction, the determining unit 21 determines that the incoming light has a wavelength peak in determining whether or not condition 2 in the scan permit condition is fulfilled. Otherwise, if the OCM unit 16 fails to detect the spectrum peak of the incoming light, the determining unit 21 determines that the incoming light has no wavelength peak.

Since the determining unit 21 determines that incoming light to the OCM unit 16 has a wavelength peak on the basis of the detection result of the OCM unit 16, the first optical transmission device 10 does not have to receive a transmission setting report from the second optical transmission device 100. In this embodiment, therefore, the transmission setting report receiving unit 18 of FIG. 1 is not provided.

In this embodiment, there arises a case where the OCM unit 16 detects a wavelength peak that differs from that of a transmission-target optical signal for the first optical transmission device 10. In order to avoid such a disadvantage, the first optical transmission device 10 in this embodiment may be provided with the transmission setting designating unit 31 of FIG. 7, and the determining unit 21 may compare the wavelength peak detected by the OCM unit 16 with wavelength peaks in the transmission setting for the first optical transmission device 10.

If the transmission setting for the first optical transmission device 10 has a wavelength peak that is the same as that detected by the OCM unit 16, the determining unit 21 may determine that the incoming light to the OCM unit 16 has a wavelength peak. Otherwise, if the transmission setting does not have a wavelength peak that is the same as that detected by the OCM unit 16, the determining unit 21 may determine that the incoming light has no wavelength peak.

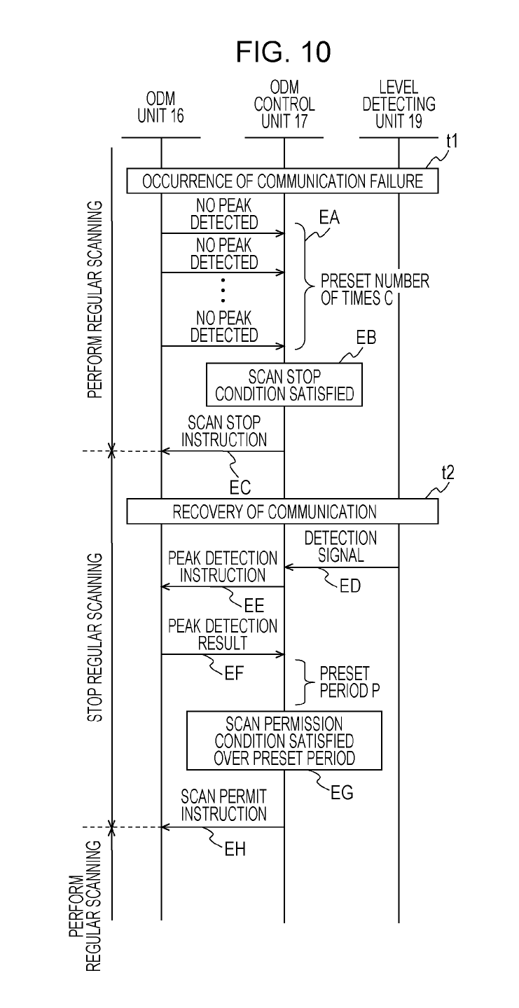

FIG. 10 is a sequence diagram of an operation of the first optical transmission device 10 in this embodiment. An optical signal does not enter the first optical transmission device 10 at Time t1 in response to the occurrence of a communication failure. Operations EA to EC are the same as operations CA to CC, respectively, in FIG. 6.

At Time t2, the communication is recovered, and the optical signal accordingly reenters the first optical transmission device 10. Operation ED is the same as operation CD in FIG. 6. At operation EE, the OCM control unit 17 outputs a peak detection instruction to the OCM unit 16.

In operation EF, the OCM unit 16 outputs a peak detection result to the OCM control unit 17, indicating that the presence or absence of the spectrum peak of incoming light. The peak detection result may contain information regarding a detected wavelength peak.

If the level detecting unit 19 detects incoming light with a light intensity equal to or more than that of at least one optical signal and the OCM unit 16 detects the spectrum peak of the incoming light, the OCM control unit 17 determines that the scan permit condition is satisfied. Operations EG and EH are the same as operations CF and CG, respectively, of FIG. 6.

In this embodiment, it is possible for the first optical transmission device 10 to determine that incoming light to the OCM unit 16 has a wavelength peak, before receiving a transmission setting report from the second optical transmission device 100. This scheme enables the first optical transmission device 10 to resume the calibration of the measured wavelength swiftly. For example, in the case where the first optical transmission device 10 monitors the light intensities of optical signals at corresponding wavelengths and calibrates the measured wavelength simultaneously, this embodiment enables the first optical transmission device 10 to resume the monitor of the light intensity at the wavelength swiftly.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device for an optical channel monitor, comprising:
at least one of a processor and a circuit configured to stop calibration of a measured wavelength when no peak intensity of a wavelength of incoming light is detected, the optical channel monitor measuring a light intensity at the measured wavelength,
the at least one of processor and circuit being configured to determine presence of a peak intensity in the incoming light when detecting the incoming light with a light intensity equal to or more than a given intensity,
the at least one of processor and circuit being configured to permit the calibration of the measured wavelength which has been stopped to be resumed when the wavelength peak is determined to be present.

2. The control device according to claim 1, wherein
the optical channel monitor is configured to measure a light intensity of an optical signal contained in the incoming light to a first optical transmission device, and
the at least one of processor and circuit is configured to determine the presence of the wavelength peak in the incoming light, on the basis of a report signal, the report signal being transmitted from a second optical transmission device, the report signal reporting a transmission of an optical signal to the first optical transmission device, the second optical transmission device differing from the first optical transmission device.

3. The control device according to claim 2, wherein
the at least one of processor and circuit is configured to determine the presence of the wavelength peak in the incoming light, on the basis of the report signal and information regarding respective wavelengths of transmission-target optical signals for the first optical transmission device.

4. The control device according to claim 3, wherein
the at least one of processor and circuit is configured to determine the presence of the wavelength peak in the incoming light, depending on whether or not there is a common wavelength between the optical signal transmitted from the second optical transmission device and the transmission-target optical signals for the first optical transmission device.

5. The control device according to claim 1, wherein
the at least one of processor and circuit is configured to detects the wavelength peak of the incoming light by using the optical channel monitor when the incoming light with a light intensity equal to or more than the given intensity is detected.

6. The control device according to claim 5, wherein
the at least one of processor and circuit is configured to determine the presence of the wavelength peak in the incoming light, depending on whether or not there is a common wavelength between the wavelength peak detected by the optical channel monitor and transmission-target optical signals for the first optical transmission device.

7. An optical transmission device, comprising:
an optical channel monitor; and
a control device including at least one of processor and circuit,
the at least one of processor and circuit configured to stop calibration of a measured wavelength when no wavelength peak of incoming light is detected from, the optical channel monitor measuring a light intensity at the measured wavelength,
the at least one of processor and circuit configured to determine presence of a wavelength peak in the incoming light when detecting incoming light with a light intensity equal to or more than a given intensity,
the at least one of processor and circuit configured to permit the calibration of the measured wavelength which has been stopped to be resumed when the wavelength peak is determined to be present.

8. A method of controlling an optical channel monitor, comprising:
stopping calibration of a measured wavelength when no wavelength peak of incoming light is detected, the optical channel monitor measuring a light intensity at the measured wavelength;
determining presence of a wavelength peak in the incoming light when detecting incoming light with a light intensity equal to or more than a given intensity; and
permitting the calibration of the measured wavelength which has been stopped to be resumed when the wavelength peak is determined to be present in the determination.
